(19) United States
(12) Patent Application Publication
(10) Pub. No.: US 2025/0098801 A1
(43) Pub. Date: Mar. 27, 2025

(54) Clean-O Safe Cleaning Tool

(71) Applicant: Russell Kramer, Sandwich, MA (US)

(72) Inventor: Russell Kramer, Sandwich, MA (US)

(21) Appl. No.: 18/372,611

(22) Filed: Sep. 25, 2023

(51) Int. Cl. A41D 19/00; A47K 10/16

(52) U.S. Cl. CPC A41D 19/0024; A41D 19/0037; A47K 10/16

(57) ABSTRACT

A method includes identifying one or more wet spots at an initial position. The method also includes configuring a glove at a position above or around the one or more wet spots. The method also includes attaching a disk of absorbent material onto the glove, wherein the disk is positioned in a center region, wherein the disk and glove are configured to protect a hand of a user at one or more intervals. The method also includes positioning the combined glove and disk on the one or more wet spots to absorb the one or more wet spots at the initial position.

### TECHNICAL FIELD

The present inventive concept relates to an article of manufacture for glove with an attached wiping material.

### BACKGROUND

A problem arises when attempting to contain bodily fluids when people are ill with a sickness. People may use tissues or paper towels to wipe off regions of the body of various liquids they wish to dispose off. However, when a portion of that tissue or paper towel is used, the paper towel and or tissue cannot be reused safely. The paper towel or tissue has to be disposed off in a safe manner. Moreover, the crumpled balls of tissue or paper towel will often be left lying around. The germs on the crumpled balls of tissue or paper can get on the surface, or even on the hands of the user, and thereby contaminate the surface and the user.

Another problem is that current tissues and paper towels or the like are not configured to be reduced in size while safely capturing the fluids off of the body of the user or the surface without contaminating the surface or the user. It is very difficult to reduce the size of the tissue and paper towel while protecting the hand of the user from coming into contact with the liquids that have to be cleaned up. When the user's hand comes into contact with the liquid, the user's hand can become contaminated.

A need exists for a wiping and absorbing material that can protect the hand of the user from the liquid and any contamination while the user is wiping the liquid off of the user or off of the surface. A need exists also to be able to use fresh portions of the cleaning material to ensure that no previously used portions are re-used, which can further contaminate the surface or even the user. The user has to be able to safely reduce the size of the cleaning material when needed and safely clean the surface or the user without further contamination. As such, a need exits for disposal cleaning system that enables the user to clean spills in multiple intervals without contaminating, the surface and the user.

### SUMMARY

In accordance with the present invention, the present invention relates to a wearable glove with an attachment material to protect the hands of users when wiping materials from one or more surfaces.

In an embodiment of the invention, a method includes identifying one or more wet spots at an initial position. The method also includes configuring a glove at a position above or around the one or more identified wet spots. The method also includes attaching a disk of absorbent material onto the glove, wherein the disk is positioned in a center region, and wherein the disk and glove are configured to protect a hand of a user at one or more intervals. Further, the method includes positioning the combined glove and disk on the one or more wet spots to absorb the one or more wet spots at the initial position.

The method also includes attaching a glove attachment device to the glove.

In an embodiment, a method includes positioning a glove at an initial position over a hand of a user. The method also includes configuring disk with absorbent material on the glove, wherein the disk is attached to the glove to absorb wet materials at one or more locations, and wherein combined disk and glove are re-positioned at one or more intervals to absorb the wet materials and protect the hand of the user. Further, the method includes forming one or more creases within the disk of the absorbent material to assist the glove and disk with absorbing the wet materials.

The method also includes identifying locations on the disk to form the one or more creases within the disk.

In an embodiment of the invention, a system includes one or more wet spots at an initial position. The system also includes a glove configured at a position above or around the one or more wet spots that are identified. Further, the system also includes a disk of absorbent material attached onto the glove, wherein the disk is positioned in a center region, wherein the disk and glove are configured to protect a hand of a user at one or more intervals. The system also includes the combined glove and disk positioned on the one or more wet spots to absorb the one or more wet spots at the initial position.

### BRIEF DESCRIPTION OF THE FIGURES

FIG. 1 illustrates a glove and disk of absorbent material in accordance with an embodiment of the invention;

FIG. 2 illustrates another depiction of a glove and a disk of absorbent material in an embodiment of the invention;

FIG. 3 illustrates a diagram of the disk of absorbent material in an embodiment of the invention;

FIG. 4 illustrates a glove and disk of absorbent material in accordance with another embodiment of the invention;

FIG. 5 illustrates a glove and disk of absorbent material in a folded position in accordance with an embodiment of the invention;

FIG. 6 illustrates a glove and disk of absorbent material in another folded position in accordance with an embodiment of the invention; and

FIG. 7 illustrates a flowchart in accordance with an embodiment of the invention.

### DETAILED DESCRIPTION

This application relates to an article of manufacture for providing personal protection to the hands of one or more users. The invention relates to a wearable glove with an attachable wiping material with a circular disk.

Various embodiments will be described in detail in the specification and in the drawings. Reference numerals represent like parts and assemblies through several views. Reference to various embodiments do not limit the scope of the invention. Further, any additional examples set forth in this specification are not intended to be limiting and merely set forth some of the many possible embodiments for the claimed invention. The phrases “at least one”, “one or more”, and “and/or” are open-ended

expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

It will be further understood that the terms “comprises,” “comprising,” “includes,” and “including” specify the presence of stated features, steps or components, but do not preclude the presence or addition of one or more features, steps or components. It should also be noted that in some alternative implementations, the functions and acts may occur out of the order noted in the figures. Two figures shown in succession may be executed substantially concurrently or may sometimes be executed in the reverse order.

The term “invention” or “present invention” refers to the invention being applied may be used interchangeably with cleaning glove and cleaning tool.

### Introduction

The present invention relates to a protective device or cleaning system that protects the hands of users when cleaning up spills and wet spots on floors, desks, tables, and other various surfaces. Spills and wet spots can also be on various portions of the body of a user. The user can have spills around the nose, mouth, or arm region in various examples. The user will want to clean the various wet spots and spills on the surfaces or on the body efficiently. The user will also not want to contaminate the surface, the user, or the hands of the user cleaning the spills or wet spots.

The cleaning system will include a glove/mitt, a disk of absorbent material in a circular shape. Other embodiments can include a disk of other shapes as well. A glove attachment device will be part of the glove. Further, a mated material attachment device will be part of the disk. All of the components will consist of the cleaning system that will be used by the user to clean wet spots and spills on various surfaces or on users.

A glove or mitt will be positioned over the hand of a user after a spill or wet spots is identified on one or more of the various surfaces. A disk of absorbent material will be attached to the glove. The disk of absorbent material can be in a circular shape. The disk can also come in other various shapes as desired or requested by the user. The user will wipe the wet spots and spills off of the surfaces and/or the user in one or more intervals.

The user will be able to fold the disk of absorbent material in multiple intervals into concave and convex creases. The folding of the disk into creases will ensure that a fresh portion of the disk is used to clean the wet spots of the spill. The user will fold the disk into another crease for each cleaning interval of the wet spot and/or spill. The user will continue the process of folding the disk into a crease until the user determines that the wet spot and/or spill has been completely absorbed and cleaned up accordingly.

The user will want to clean various spills and wet spots on a ground surface or a table surface or the like without contaminating the surface, the user, or the hand of the user. The cleaning system with the glove and disk will protect the hand of the user from any contamination that would result from the hand coming into contact with the wet spot and/or spill. Further, the disk being folding into different creases will ensure that the cleaning system will not be contaminated or the surface or the user will not be contaminated by re-using a previously used portion of the disk to clean the wet spot and/or spill.

### Analysis

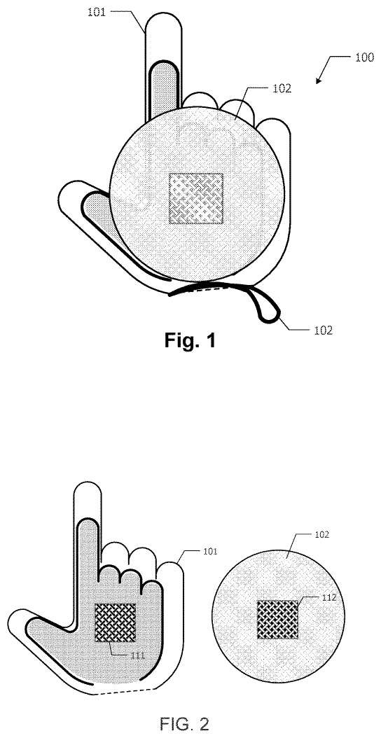

Referring to FIG. 1, a cleaning system 100 is illustrated. In addition, a glove/mitt 101 positioned on a user's hand is shown. In addition, a disk 102 with absorbent material with a drawstring is connected to the disk 102. The drawstring will provide additional leverage to handle the disk 102 and also act as a closing mechanism. The disk 102 will be made of facial tissue and/or microfiber disposable cloth, or sandpaper. As will be shown in various embodiments, the disk 102 can be folded in multiple intervals to clean up spills and liquids on a person's body or on various surfaces.

Still referring to FIG. 1, the user's hand can be positioned over a spill or wet spot on a table surface, or a floor. The user's hand can also be positioned over other surfaces with spills or wet spots. The cleaning system 100 can also be placed over a user's body to clean up any spills. Once the user has identified the spill or wet spot to be cleaned up, the user will put the cleaning system 100 on the user's hand. The liquids can include, and are not limited to, solvents, cleaning fluids, stains, paint, blood, fluid from the nose, and fluid from the mouth. The cleaning system 100 includes the glove 101 and disk 102 of absorbent material. After the spills or wet spots are identified, the glove 101 will be placed over the user's hand. The disk 102 will then be attached to the glove 101. The disk 102 will be circular in shape. The disk 102 will also be folded one or more times as desired by the user. For each fold, a new crease of fresh material is used on the disk 102. As such, the previous portion of the disk 102 that has wiped part of the wet spot or spill will not be re-used, and not further contaminate the surface or user. As will be shown in later embodiments, creases can be performed within the combination 102 to assist the cleaning device 100 in absorbing spills and wet spots and protect the hand of the user. The multiple creases will use a previously unused portion of the disk 102 to absorb the wet spots or spills.

Referring to FIG. 1, the combination including the glove 101 and the disk 102 are placed by the user on the spill on the user's body, or on a surface with wet spots or spills. The user will fold the disk 102 within the combination into one or more creases (as will be shown in later embodiments). The disk 102 within the combination will absorb the spill on the user's body or on the table or ground surface. The user's hand will not come into contact with the spill. Both the glove 101 and disk 102 with absorbent material within the combination of the cleaning system 100 will protect the user from any germs or contamination that could occur from coming into contact with the spill or wet spot, or should a user be using the disk 102 and glove 101 to clean up materials from the user's nose by blowing the user's nose.

In FIG. 2, another view of the cleaning system is illustrated. The combination is shown separated. The glove/mitt 101 on the user's hand is shown separately from the disk 102 with the absorbent material. Moreover, attached to the glove 101 is a glove attachment device 111. Further, a mated material attachment device 112 is attached to the disk 102 of absorbent material. The mated material attachment device 112 will easily be attached to the glove attachment device 111 using velcro or other attachment mechanisms. The coupling of the glove attachment device 111 and the mated material attachment device 112 will be aligned along with the glove 101 and disk 102. As such, when the user spots a spill in the nose or mouth of the user, or on a table or ground surface, the user will use the combined system 100 to clean the spill on the ground surface or body. The users can fold the disk 102 that includes that mated material attachment device 112 into the necessary amount of creases to clean the spills. Each crease, as will be shown later, will include new material that can clean the spill. The new material will ensure that no previously used portion of the disk 102 is used to clean the wet spot and/or spill, which can result in the user and the surface becoming contaminated.

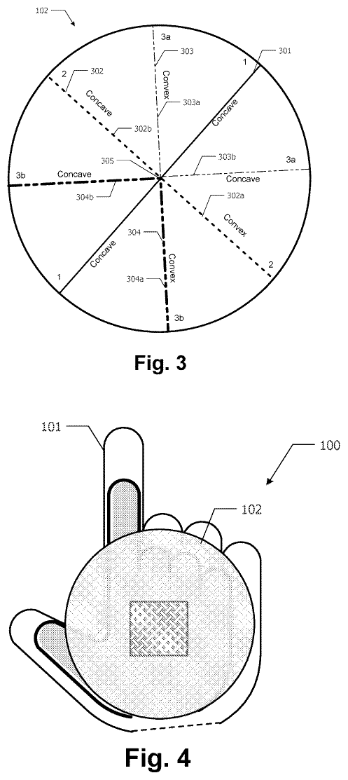

In FIG. 3, the disk 102 of absorbent material is illustrated in more detail. A plurality of creases can be formed within the disk 102. Each time the user's wipes a ground surface or spill on a body part, the user will fold the disk into a crease. The user will fold the disk 102 into a crease to ensure that a new and unused portion of the disk 102 is used to wipe the spill. As such, a previously used portion of the disk 102 is not re-used on the spill, which could further contaminate the surface or the user.

Referring to FIG. 3, a set of creases 301, 302, 302a, 302b, 303, 303a, 303b, 304, 304a, and 304b are illustrated. Points 1, 2, 3a, and 3b are also shown. The creases 301-304b can be scored, stamped, or mechanically created. Further, the creases 301-304b are oriented along concave or convex lines to enable a user to reduce a size of the disk 102 by folding it in size by a predetermined pattern. The set of creases 301-304b illustrate new portions of the disk 102 that will be used to ensure that an unused portion of the disk 102 is used to wipe the spill off of the surface or off of the user. The spill can be bad waste or chemicals on a ground surface that will harm the user should any portion of the waste/chemicals come onto the user. Further, the user will not use a previously used portion of the disk 102 to wipe a nose bleed, or other liquid that may be on the user, which could lead to the user being infected and spreading germs to others.

In FIG. 3, the creases 301-304b are either concave or convex in a predefined pattern. In particular, the creases 302a, 303, 303a, 304, 304a are convex. In addition, the creases 301, 302, 302b, 303b, and 304b are concave creases. Point 305 illustrates the center point of the disk 102. At least eight different creases can be formed within the disk 102 as shown in FIG. 3. The user can wipe the spill off of the ground/table surface, or off of the body of the user. The various different creases 301-304b will ensure that no previously used portion of the disk 102 is used to wipe the spill, and thereby further contaminate the ground or the user.

Referring to FIG. 4, another illustration of the cleaning system 100 is shown. The cleaning system 100 will include the glove/mitt 101 positioned over the hand of the user. The cleaning system 100 will also include the disk 102 with the absorbent material that is coupled to the glove. In addition, the glove attachment device and the mated material attachment device will be part of the cleaning system. The glove attachment device will be part of the glove 101, while the mated material attachment device will be part of the disk 102.

In FIG. 4, the user will identify a wet spot or spill on the user or another user. Further, or alternatively, the user will identify a wet spot or spill on a table surface or ground surface. The user will place the cleaning system 100 over and on the wet spot or spill. Moreover, the user will fold creases within the disk 102 to ensure that no previously used portion of the disk 102 wipes up the spill or wet spot. If the spill or wet spots require multiple wipes to remove the wet spot or spill from the body of the user or table or ground surface, the user will fold the disk 102 in multiple intervals. Moreover, the disk 102 can be folded eight or more times into creases with an unused portion of the disk 102 to wipe up the spill or wet spot. As such, a new portion of the disk 102 will be used to wipe and absorb the wet spot and/or spill at each interval.

Still referring to FIG. 4, the user is free to move his hand with the cleaning system 100 in any direction. The user can tap on the spill, or use a wiping motion, or any other motion that will allow the disk 102 to clean the spill or wet spot on the surface or on the user. After the user has located the spill on the surface or on the user, the user will fold the disk 102 into one crease. The crease can be a concave or convex crease. The user will repeatedly fold the disk as necessary to ensure that the entire portion of the spill and wet spot has been cleaned. Throughout the cleaning process, the hand of the user is protected by the cleaning system. The user' s hand is not contaminated by the wet spot or spill. As such, if something from the user's nose or arm such as blood is being wiped, each time an unused portion of the disk will wipe the blood until the blood is completely wiped off of the user. No portion of the blood will contaminate the user. Further, no previously used portion of the disk 102 will contaminate the user by re-wiping the blood using a previously used portion of the disk 102.

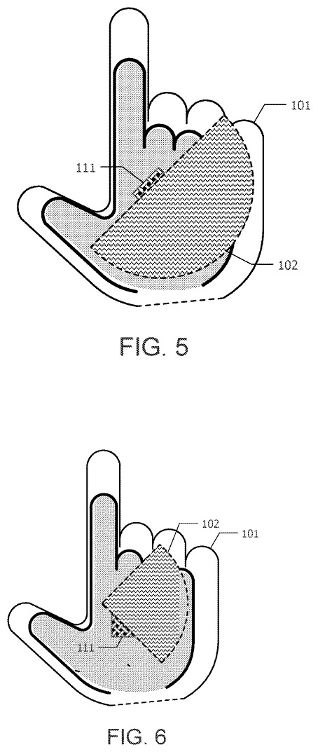

In FIG. 5, another example of the cleaning system 100 is illustrated. The cleaning system 100 is shown with the glove 101, the glove attachment device 111 on the glove 101, and the disk 102 of absorbent material coupled to the glove 101 and the glove attachment device 111. The user will locate the spill or wet spot such as a user needing to blow his nose, or clean a wet spot on a table or ground surface. Wet spots and spills are not limited to such examples, and can include various other examples. After the user has identified the wet spot or spill to be cleaned, the user will ensure that a clean portion of the disk 102 is used. The user will prevent any previously used portion of the disk 102 from being re-used, and causing contamination, by folding the disk 102 as shown.

In FIG. 5, The disk 102 of absorbent material is coupled to the glove/mitt 101. As shown in FIG. 5, half of the disk 102 is folded in half. The user can determine to fold one quarter of the disk 102, or half of the disk 102 to clean up the spill or wet spot on the surface or on a user or the user. The creases will be either concave or convex in a predefined pattern. The disk 102 enables the user to apply an absorbent material that is capable of wiping and absorbing the spill or wet spot. Further, the disk 102 enables an unused portion to absorb and wipe the spill. After a wiping interval, the user can determine if any further wiping or absorbing intervals are required. Based on the user's determination, the user will fold the disk 102 to an appropriate area to continue another wiping and absorbing interval. The user will continue to fold the disk 102 further until the user has determined that the wet spots or spills have been completely absorbed and wiped. The user will identify and fold the disk 102 as often or as little as possible to wipe and absorb wet spots and spills on surfaces or on the user or other users.

Referring to FIG. 6, the cleaning system 100 is illustrated in another embodiment. The cleaning system 100 includes the glove/mitt 101 on the hand of the user. The glove attachment device 111 is also configured on the glove 101. The disk 102 of absorbent material is also positioned on the glove 101 and the glove attachment device 111.

In FIG. 6, the disk 102 of absorbent material is shown to be fold more than once. The user, during wiping intervals or before a wet spot and spill are cleaned from a user or surface, will determine the number of intervals that are needed to wipe and/or absorb the wet spots and/or the spills. The disk 102 is shown to have only one quarter region left. The previous creases within the disk 102 will not be reused. The user will ensure that no previously used creases of the disk 102 will not be reused to prevent contamination on the surface or on the user. The user will also determine how large the crease will be when folding the disk 102. As such, the user will determine how large the new folding area of the disk 102 will be. The user will thereby determine if a large area, or small area of the disk 102 needs to be folded to wipe and absorb the spill or wet spot(s) off of the user and/or the surface.

Referring again to FIG. 6, the remaining quarter region of the disk 102 within the cleaning system 100 will be used in its entirety. Alternatively, the user can also determine that a small portion of the remaining portion of the disk 102 will folded to further wipe and absorb the wet spots. The user will thereby continue to further fold the disk 102 and ensure that only an un-used portion of the disk 102 is used to further wipe and absorb the wet spot and/or spill.

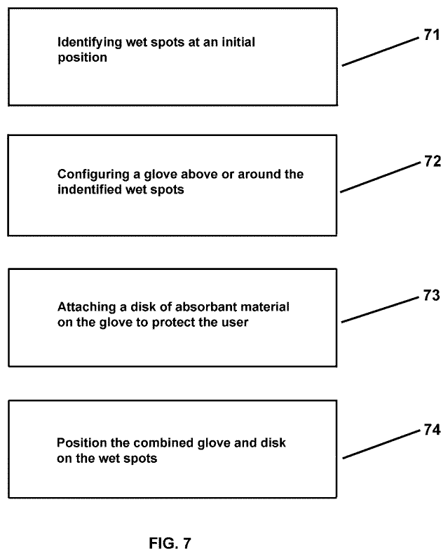

In FIG. 7, a method 70 is illustrated. The method 70 will illustrate how the user will identify wet spots and spills on a surface and/or on the user. The method 70 will also illustrate how the user will then place the cleaning system with the glove/mitt and disk of absorbent material over and on the spills and wet spots to absorb and wipe the wet spots and spills from the surface, and/or the users.

Referring to FIG. 7, and step 71, wet spots and/or spills will be identified. A place on the user's body, or on another user's body could have a spill or wet spot. Blood could be trickling from the user. One or more items of fluid could be coming from the user's mouth or nose. Further, table or ground surfaces could have spills that need to be cleaned. As such, the user will identify the surface and/or portion of the body of the user that needs to have the cleaning system wipe and absorb the spill and/or wet spot. Multiple points on the user or on the surface can be identified for cleaning.

In FIG. 7, at step 72, the glove/mitt and disk of the cleaning system will be positioned over the identified wet spots and/or spills. The glove will include the glove attachment device, while the disk will include the mated material attachment device. The user will place the glove combined with the disk over the surface or over the user in order to wipe and absorb the spill. The user will fold the disk into one or more creases to wipe and/or absorb the spill. The user will ensure that no previously used portion of the disk is used when wiping and absorbing the wet spot and/or spill. As such, no further contamination will occur on the ground surface and/or on the user.

In FIG. 7, at step 73, the disk of absorbent material will be attached to the glove. The disk of absorbent material will include a mated material attachment device. The glove will include a glove attachment device. The disk will be coupled to the glove through the entire cleaning process of the spill and/or wet spot. The glove and disk will protect the hand of the user from any contamination. No portion of the wet spot and/or spill will come into contact with the user. As such, the user is protected by the glove and disk from any contamination that will result from the wet spot and/or spill.

In FIG. 7, at step 74, the glove and disk are positioned on the wet spot and/or spill to wipe and/or absorb the wet spot and/or the spill. The user will fold the disk into a plurality of creases. The user will wipe the wet spot and/or spill in multiple intervals if required. The user will continuously fold portions of the disk as required. The creases of the disk will be either concave or convex in a predetermined pattern. The user will decide the amount of folding required to ensure that an unused portion of the disk is used to completely absorb and wipe the spill and/or wet spot off of the surface and/or the user. The unused portion will ensure that no previously used portion of the disk is used to clean up the wet spot and/or spill, and thereby cause contamination.

### Advantages/Summary

The above embodiments of the present invention describe the cleaning system. In addition, the various components of the cleaning system are described in detail. The cleaning system includes a glove/mitt placed on the hand of the user. The cleaning system also includes a disk of circular shape in various embodiments. The disk will have absorbent material. The disk will be coupled to the glove. The combined glove and disk will be used to wipe and absorb a spill and/or wet spot on the body of the user or other users, or on a surface such as the ground or the table. A glove attachment device will be attached to the glove, while a mated material attachment device will be attached to the disk. The combined cleaning system will be able to thoroughly clean any spill or wet spot on a surface or on a user while protecting the hand of the user from any contamination.

The user will want to clean up a spill on his body such as his/her mouth or nose without contaminating the hands or the body. Further, the user will also want to clean up wet spots or spills on a table or on the ground or other surfaces without contaminating the hands or the surface. The user will place the cleaning system on the hand to protect the hand from contamination from the wet spot or spill while wiping and absorbing the wet spot or spill.

The user will also ensure that a fresh portion of the cleaning system is used on each portion of the spill or wet spot. The cleaning system will ensure that no previously used portion of the cleaning system will be used to re-clean a portion of the wet spot or spill. The disk of absorbent material will have convex and concave regions that will enable the disk to be folded into a series of creases. The disk will have a series of creases that will each be used to clean a portion of the spill. With the different creases within the disk, no previously used portion of the disk will be used to clean a spill or wet spot on the surface or on the user. The user will fold the disk of absorbent material into another crease when a portion of the wet spot or spill remains. As the user is cleaning the spill or wet spot, the hand of the user remains protected from contamination. The cleaning system prevents the user from being contaminated by the wet spot or spill. Further, the creases within the disk ensure that a fresh portion of the disk is used each time to clean the wet spot or spill until the wet spot or spill has been completely wiped and absorbed.

The cleaning system provides safety to the hand of the user to safely cleanly multiple spills and wet spots on surfaces on the user or other users. In addition, the cleaning system enables a fresh portion of the cleaning system to be used to clean the wet spots and spills in multiple intervals. Each time the user wipes a portion of the wet spot or spill, the user can fold the disk into a crease to ensure that a fresh portion of the cleaning system is used to clean and absorb the wet spot. Therefore, no contamination will occur to the cleaning system or to the user or surface as a result of reusing a previously used portion of the disk for cleaning.

1. A method comprising:
identifying one or more wet spots at an initial position;
configuring a glove at a position above or around the one or more wet spots that are identified;
attaching a disk of absorbent material onto the glove, wherein the disk is positioned in a center region, and wherein the disk and glove are configured to protect a hand of a user at one or more intervals; and
positioning the combined glove and disk on the one or more wet spots to absorb the one or more wet spots at the initial position.

2. The method of claim 1, further comprising:
attaching a glove attachment device to the glove.

3. The method of claim 1, further comprising:
attaching a mated attachment device to the disk of the absorbent material.

4. The method of claim 1, further comprising:
forming one or more creases within the disk of the absorbent material.

5. The method of claim 1, further comprising:
reducing a size of the disk of the absorbent material to absorb the one or more wet spots.

6. The method of claim 1, further comprising:
folding the disk of the absorbent a material according to a predetermined pattern.

7. The method of claim 1, further comprising:
forming at least one crease at a first and second location.

8. A method comprising:
positioning a glove at an initial position over a hand of a user;
configuring disk with absorbent material on the glove, wherein the disk is attached to the glove to absorb wet materials at one or more locations, and wherein the combined disk and glove are re-positioned at one or more intervals to absorb the wet materials and protect the hand of the user; and
forming one or more creases within the disk of the absorbent material to assist the glove and disk with absorbing the wet materials.

9. The method of claim 8, further comprising:
identifying locations on the disk to form the one or more creases within the disk.

10. The method of claim 8, wherein a first crease formed within the disk with the absorbent material is formed at an angle greater or equal to forty-five degrees.

11. The method of claim 8, further comprising:
folding the disk with the absorbent material in one or more directions to absorb the wet materials.

12. The method of claim 8, further comprising:
identifying a location on the disk with the absorbent material to attach a mated attachment device.

13. The method of claim 8, further comprising:
forming the absorbent material at an outside edge and center location of the disk.

14. The method of claim 8, further comprising:
forming a crease along an entire length of the disk of the absorbent material.

15. A system comprising:
one or more wet spots at an initial position;
a glove configured at a position above or around the one or more wet spots that are identified; and
a disk of absorbent material attached onto the glove, wherein the disk is positioned in a center region, wherein the disk and glove are configured to protect a hand of a user at one or more intervals, and wherein the combined glove and disk are positioned on the one or more wet spots to absorb the one or more wet spots at the initial position.

16. The system of claim 15, wherein the disk of absorbent material is configured as a circular shape.

17. The system of claim 15, wherein a plurality of creases are positioned at various positions on the disk of absorbent material.

18. The system of claim 15, wherein the disk of absorbent material is folded at one or more intervals to absorb the one or more wet spots.

19. The system of claim 15, wherein one or more creases within the disk of absorbent material is formed into a convex shape.

20. The system of claim 15, wherein disk of absorbent material is folded by a user on at least two intervals.
